(19) United States
(12) Patent Application Publication
(10) Pub. No.: US 2009/0177871 A1
(43) Pub. Date: Jul. 9, 2009

(54) ARCHITECTURAL SUPPORT FOR SOFTWARE THREAD-LEVEL SPECULATION

(76) Inventors: Christoph Von Praun, Briarcliff Manor, NY (US); Michael F. Spear, Rochester, NY (US)

Correspondence Address: F. CHAU & ASSOCIATES, LLC, 130 WOODBURY ROAD, WOODBURY, NY, 11797, US

(21) Appl. No.: 11/971,115

(22) Filed: Jan. 8, 2008

(51) Int. Cl. G06F 9/30

(52) U.S. Cl. 712/226; 712/E09.016

(57) ABSTRACT

A system for thread-level speculation includes a memory system for storing a program code, a plurality of registers corresponding to one or more execution contexts, for storing sets of memory addresses that are accessed speculatively, and a plurality of processors, each providing the one or more execution contexts, in communication with the memory system, wherein a processor of the plurality of processors executes the program code to implement method steps of dividing a program into a plurality of epochs to be executed in parallel by the system, wherein one of the epochs is executed non-speculatively and the other epochs are executed speculatively, determining a current epoch to be executed on an execution context, encoding addresses read during execution of the current epoch, encoding addresses written during execution of predecessor epochs of the current epoch, and encoding addresses written during execution of successor epochs of the current epoch.

### BACKGROUND OF THE INVENTION

1. Technical Field

The present disclosure relates to architectural extensions of a microprocessor that support the execution of a software runtime system for thread-level speculation.

2. Discussion of Related Art

On multiprocessor and multi-core computers, the multiple processors or cores may execute multiple threads concurrently, with different threads of a given process running on different processors or cores. For example, in systems using symmetric multiprocessing, typically any processes, including those of the operating system, can run on any available processor, and the threads of a single process can run on different processors at the same time.

In multiprocessor systems, shared memory needs to be kept consistent, wherein the integrity of data stored in local caches of each processor is preserved. This is known as cache coherency. Various models and protocols have been devised for maintaining cache coherence, such as the MESI protocol, MSI protocol and MOESI protocol. Typically, the cache coherence protocols in multiprocessors support a sequential consistency model. For sequential consistency, a globally (i.e., across all memory locations) consistent view of memory access operations is taken. For example, a system provides sequential consistency if every node of the system sees the write operations on the same memory cell in the same order.

Thread-level speculation (TLS) is a technique that allows a sequential computation to be divided into a sequence of “epochs” and enables sequentially consistent, concurrent execution of the epochs even though memory access in different epochs may be data dependent. For thread-level speculation, the epochs are ordered corresponding to their occurrence in the original sequential program. In TLS, epochs are typically executed in different threads.

In general, speculative execution is the execution of code the result of which may not be needed. In the context of thread-level speculation, speculative execution means that side-effects such as memory updates or I/O operations are not made visible to other epochs until the execution of the epoch performing the side-effect is confirmed to be safe, e.g., all epochs preceding it in the linear order have successfully completed. When epochs with data dependences execute concurrently, it may occur that an epoch, e.g., denoted “e1”, reads a value from memory that is (later in the real time) changed by another epoch, e.g., denoted “e2”, where e2 precedes e1 in the linear order. In such event, execution of epoch e1 fails.

The functional aspects of thread-level speculation may include the start of a new epoch, versioning, conflict detection, rollback and ordered commit, etc. Start of a new epoch refers to a mechanism to create a speculative execution context, define the epoch's position in the speculation order, and start execution of the epoch. Versioning refers to a mechanism to confine updates of shared memory within the speculative execution context of an epoch until the epoch becomes non-speculative. Versioning support allows a system to tolerate output (write after write) and anti- (write after read) data dependences among concurrent tasks. Conflict detection refers to a mechanism to detect data dependence violations among tasks. For example, an epoch reads a value from a location that is updated concurrently by another epoch that is a predecessor in the speculation order, which is a violation of flow dependence: read after write. Rollback refers to a mechanism to restart the computation of a failed speculative computation. Ordered commit refers to a mechanism that controls the order in which epochs become non-speculative and makes their side effects accessible.

Hardware support for TLS commonly retains speculative versions of data in cache or a separate hardware buffer, in either case, with limited capacity. The cache coherence protocol may be extended to detect a violation of data flow dependence among epochs executing concurrently on different hardware threads. Hardware-centric implementations of TLS affect design complexity, for example, integral processor components, such as the load-store unit and cache, are affected by TLS extensions, and conflict detection is performed at a granularity of cache lines, which can lead to false conflicts and decrease the parallelization efficiency of the mechanism.

Software support for TLS has been proposed that primarily relies on auxiliary data and control structures that enable data versioning and conflict detection. Auxiliary data and control structures and checks are commonly synthesized by the compiler. A reduced version of all epochs may be executed sequentially for the purpose of conflict detection and, after if a conflict is determined/detected, a full version of the epochs may be executed without speculation, in parallel, otherwise resorting to serial execution.

Systems for TLS may provide baseline TLS operations in hardware and may offload selected operations such as buffering of speculative state to software. In these and other contexts, there is a need for reduced hardware implementation complexity in computer systems with support for TLS.

### SUMMARY OF THE INVENTION

According to an exemplary embodiment of the present invention, a system for thread-level speculation includes a memory system for storing a program code, a plurality of registers corresponding to one or more execution contexts, for storing sets of memory addresses that are accessed speculatively, and a plurality of processors, each providing the one or more execution contexts, in communication with the memory system, wherein a processor of the plurality of processors executes the program code to implement method steps of dividing a program into a plurality of epochs to be executed in parallel by the system, wherein one of the epochs is executed non-speculatively and the other epochs are executed speculatively, determining a current epoch to be executed on an execution context, encoding addresses read during execution of the current epoch, encoding addresses written during execution of predecessor epochs of the current epoch, and encoding addresses written during execution of successor epochs of the current epoch.

According to an exemplary embodiment of the present invention, a system for thread-level speculation includes a memory system for storing a program code, a first register, a second register and a third register, the first, second and third registers for storing sets of memory addresses that are speculatively accessed, and a plurality of processors, each providing the one or more execution contexts, in communication with the memory system, wherein a processor of the plurality of processors executes the program code to implement method steps of dividing a program into a plurality of epochs to be executed in parallel by the system, wherein one of the epochs is executed non-speculatively and the other epochs are executed speculatively, and determining a current epoch to be executed on an execution context, wherein the first register stores addresses read during execution of a current epoch, the second register stores addresses written during the execution of predecessor epochs of the current epoch, and the third register stores addresses written during the execution of successor epochs of the current epoch.

The present invention will become readily apparent to those of ordinary skill in the art when descriptions of exemplary embodiments thereof are read with reference to the accompanying drawings.

### BRIEF DESCRIPTION OF THE DRAWINGS

FIG. 1 is a block diagram of a data processing system, which may be used to implement an exemplary embodiment of the present invention.

FIGS. 2A and 2B are block diagrams that illustrate multiple execution contexts and their logical ordering according to the order of epochs that they execute, according to exemplary embodiments of the present invention.

FIG. 3 is a block diagram schematically illustrating an architecture of a thread-level speculation system, according to an exemplary embodiment of the present invention.

FIG. 4 is a diagram that illustrates a parallel computation with epochs, according to an exemplary embodiment of the present invention.

FIG. 5 is a flowchart that illustrates high level operation of an execution context, according to an exemplary embodiment of the present invention.

FIG. 6 is a flowchart illustrating the start of an epoch, according to an exemplary embodiment of the present invention.

FIG. 7 is a flowchart illustrating a speculative write operation, according to an exemplary embodiment of the present invention. This operation is also referred to as write barrier in the following.

FIG. 8 is a flowchart illustrating a speculative read operation, according to an exemplary embodiment of the present invention. This operation is also referred to as read barrier in the following.

FIG. 9 is a flowchart illustrating the detection of data dependences among epochs, according to an exemplary embodiment of the present invention. This operation is also referred to as conflict detection or validation in the following.

FIG. 10 is a flowchart that illustrates the algorithm to end an epoch, according to an exemplary embodiment of the present invention. This operation is also referred to as commit in the following.

### DESCRIPTION OF EXEMPLARY EMBODIMENTS

Hereinafter, exemplary embodiments of the present invention will be described with reference to the accompanying drawings.

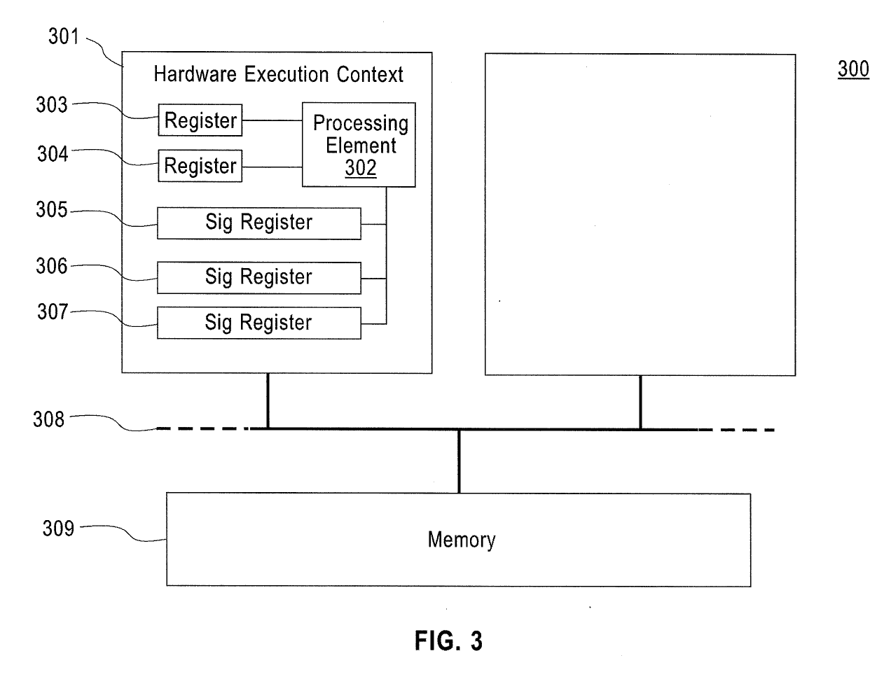

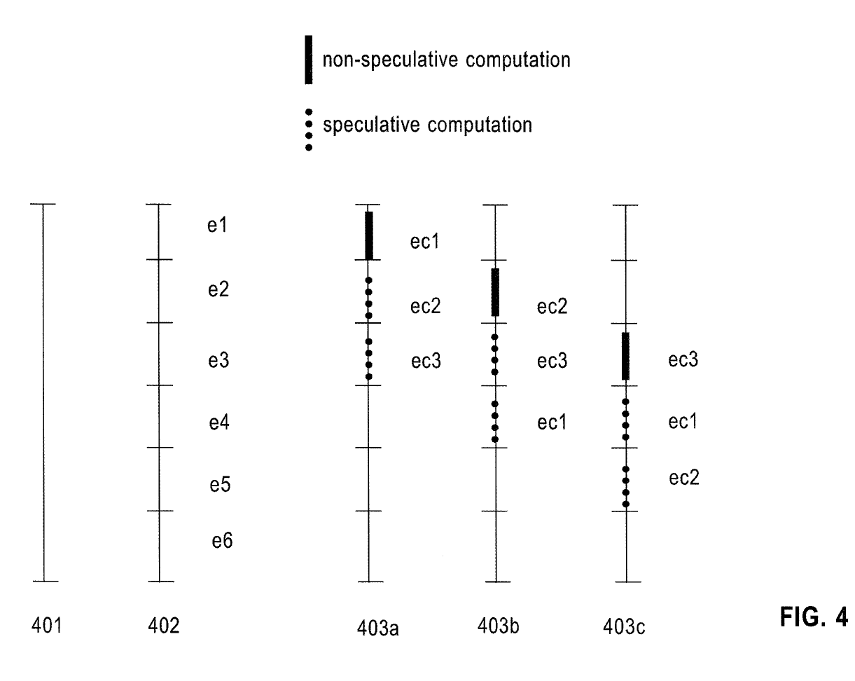

In various exemplary embodiments of the present invention, a processor or multiprocessor system has multiple hardware execution contexts (or “execution contexts”). A computer system with support for thread-level speculation (TLS), according to various exemplary embodiments of the present invention, includes various architectural extensions and resources that support operations of TLS. FIG. 3 is a block diagram schematically illustrating an architecture of a thread-level speculation system, according to an exemplary embodiment of the present invention.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a computer system comprising any suitable architecture.

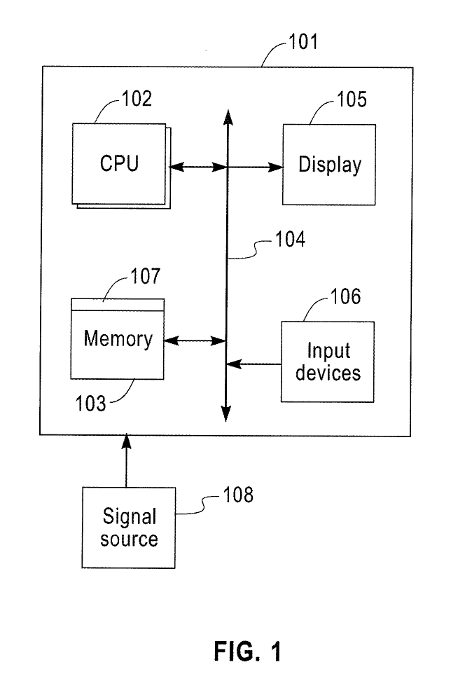

Referring to FIG. 1, according to an embodiment of the present invention, a computer system 101 for implementing a software runtime system for thread-level speculation can comprise, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, etc., or a combination thereof. The present invention can be implemented as a routine 107 that is stored in memory 103 and executed by the CPU 102 to process the signal from the signal source 108. As such, the computer system 101 is a general purpose computer system that becomes a specific purpose computer system when executing the routine 107 of the present invention.

The computer platform 101 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

It will be appreciated that the hardware depicted in FIG. 1 may vary depending on the implementation. Other internal hardware or peripheral devices, such as flash memory, equivalent non-volatile memory, or optical disk drives and the like, may be used in addition to or in place of the depicted hardware.

It is to be understood that a program storage device can be any medium that can contain, store, communicate, propagate or transport a program of instructions for use by or in connection with an instruction execution system, apparatus or device. The medium can be, for example, an electronic, magnetic, optical, electromagnetic, infrared, or semiconductor system (or apparatus or device) or a propagation medium. Examples of a program storage device include a semiconductor or solid state memory, magnetic tape, removable computer diskettes, RAM (random access memory), ROM (read-only memory), rigid magnetic disks, and optical disks such as a CD-ROM, CD-RAN and DVD.

A data processing system suitable for storing and/or executing a program of instructions may include one or more processors coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution.

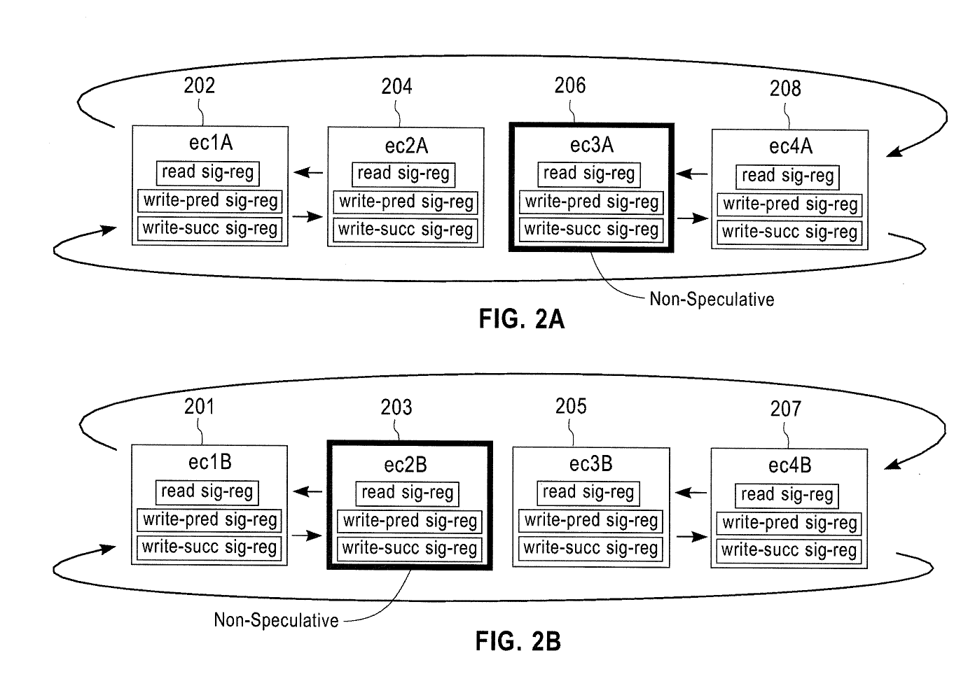

FIGS. 2A and 2B are block diagrams that illustrate multiple execution contexts and their logical ordering according to the order of epochs that they execute, according to exemplary embodiments of the present invention. In FIGS. 2A and 2B, the rightward- and leftward-pointing arrows indicate the linear order among the epochs that execute on the execution contexts. More particularly, the rightward-pointing arrows indicate a successor relationship and the leftward-pointing arrows indicate a predecessor relationship. It is to be understood that although an architecture with four execution contexts ec1A-ec4A (202, 204, 206 and 208) and ec1B-ec4B (201, 203, 205 and 207) are shown in FIGS. 2A and 2B, respectively, architectures having a different number of execution contexts may be implemented.

The execution contexts ec1A-ec4A (202, 204, 206, 208) and ec1B-ec4B (201, 203, 205, 207), in FIGS. 2A and 2B, respectively, each include three registers (referred to herein as “signature registers” or “sig-registers”). The sig-registers include a read sig-register, a write-pred sig-register and a write-succ sig-register. These sig-registers will be described later in this disclosure in connection with an exemplary embodiment described with reference to FIG. 3.

Referring to FIG. 2A, one execution context, namely, ec3A (206), is designated as non-speculative. The execution contexts ec1A (202), ec2A (204) and ec4A (208) execute speculatively.

As shown in FIG. 2A, execution context ec3A (206) is a predecessor to ec4A (208), ec1A (202) is a predecessor to ec4A (208), and ec2A (204) is a predecessor to ec1A (202). Here, execution context ec3A (204) has no predecessor. In terms of successor relationships, the successor to ec3A (206) is ec4A (208), the successor to ec4A (208) is ec1A (202), and the successor to ec1 (202) is ec2 (204). Here, execution context ec2A (204) has no successor.

Referring to FIG. 2B, one execution context, in this case, ec2B (203), is designated as non-speculative. The execution contexts ec1B (201), ec3B (205) and ec4B (207) execute speculatively.

Referring to FIG. 3, the thread-level speculation system 300 includes a hardware execution context 301, a communication system 308 through which execution context exchange data or communicate signals, and a shared memory 309. For example, the execution contexts 301 may store a read and write log in the shared memory 309.

FIG. 3 shows a hardware execution context 301 that includes a processing element 302, a register 303 that specifies whether the execution context is speculative or non-speculative, a register 304 that specifies the linear order (e.g., sequence number) of the epoch currently executing on the execution context and three signature registers 305, 306 and 307. For example, the processing element 302 may be a processor core or hardware thread. A signature register may be defined as a register that holds an encoded representation of sets of memory addresses. In this disclosure, signature registers are also referred to as “sig-register”. Although not shown as such in FIG. 3, the signature registers 305, 306 and 307 and/or register 303 and 304 may be disposed within the processing element 302.

In an exemplary embodiment of the present invention, the three signature registers 305-307 are implemented as (i) a read sig-register, which stores an encoded addresses read during execution of the current epoch, (ii) a write-pred sig-register which stores encoded addresses written during the execution of epochs that precede the current epoch in the sequential execution (predecessor epochs), and (iii) a write-succ sig-register which stores encoded addresses written during the execution of epochs that succeed the current epoch in the sequential execution (successor epochs).

Signature registers 305-307 may store 1-4K bits, for example. Signature registers 305-307 may contain superset representations of address sets where individual addresses are encoded as bitmask hash values, such as for example, through a Bloom filter.

The processor 302 may issue instructions to reset (clear) the individual sig-registers 305-307, instructions to swap register contents, and/or instructions to add a datum (e.g., address of a memory location) to a set register, for example, to compute set intersection and set membership based on Bloom filter operations. A processor may provide a mechanism to add a datum (e.g., an address of a memory location) to a signature register of another processor.

In various exemplary embodiments of the present invention, a processor or multiprocessor system has multiple hardware execution contexts. In an implementation of multiple hardware execution contexts, a linear order is maintained among the hardware contexts. For example, the linear order may be specified through a unique identification (“id”) that is associated with each hardware execution context. This id can be held in a dedicated register 304. A hardware execution context includes a dedicated register 303 that specifies if the execution context is speculative or non-speculative. In an exemplary embodiment of the present invention, the information held in register 303 is used to optimize memory read and write operations, wherein speculative execution memory read and write accesses are accompanied by software read and write barriers, and wherein execution of such barriers is not required in a non-speculative execution. If a processor computes in non-speculative mode, it is the “owner of the commit token”. There is exactly one commit token in the system. A processor may issue an instruction that enables an execution context to determine if it is owner of the commit token. An issued instruction may pass on the commit token from one hardware context to its successor in the linear order.

A computer system with support for TLS, according to various exemplary embodiments of the present invention, encompasses a number of functional aspects including ones for (1) starting a new epoch, (2) versioning updates of shared memory, (3) conflict detection, (4) rollback of an epoch that failed and (5) ordered commit of epochs.

For purposes of clarity and simplicity, the following disclosure is generally directed to an execution context that executes exactly one epoch from start to end. In such cases, execution contexts are ordered according to the successor/predecessor relationship of the epoch that they execute.

FIG. 4 is a diagram that illustrates a parallel computation with epochs, according to an exemplary embodiment of the present invention. Referring to FIG. 4, column 401 depicts a sequential execution featuring a sequence of instructions. Column 402 depicts a partitioning of the instruction sequence into epochs e1 to e6. Columns 403a to 403c illustrate how the computation of the epochs e1 to e6 proceed on an architecture with three execution contexts ec1 to ec3. Initially epoch e1 is executed on ec1, etc. Each execution context executes the foremost (oldest) epoch (ec1 in column 403a, ec2 in column 403b and ec3 in column 403c) non-speculatively. The execution context that computes an epoch non-speculatively is said to be “the owner of the commit token”. When ec1 ends its execution of epoch e1 (column 403a), it continues its operation by starting a speculative computation of a new epoch e4 (column 403b).

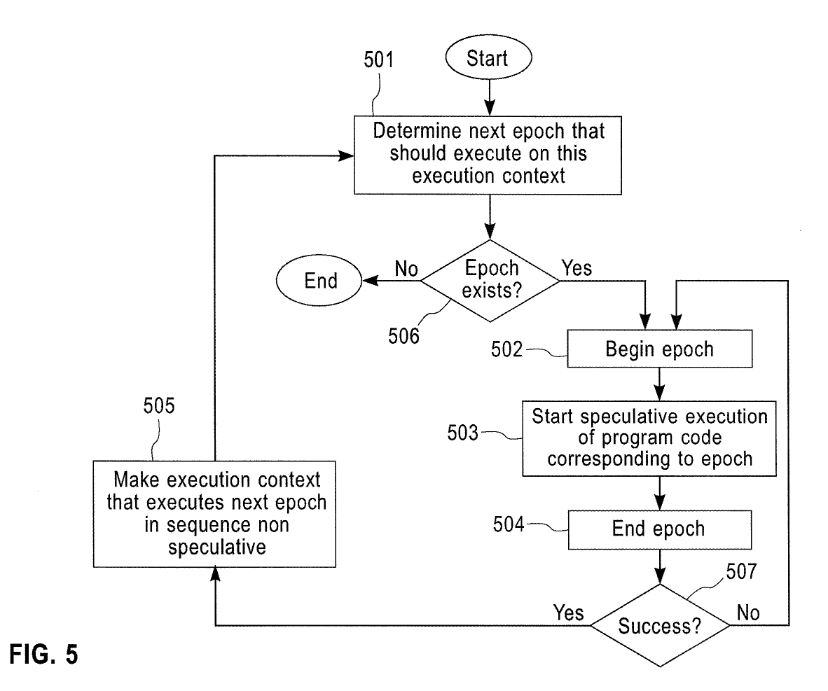

FIG. 5 is a flowchart that illustrates high level operation of an execution context, according to an exemplary embodiment of the present invention. An execution context repeatedly executes epochs. The computation is speculative at first and becomes non-speculative at the time of commit or when the epoch that constitutes the predecessor in the sequential order ends successfully.

Referring to FIG. 5, in block 501, determine an epoch to be executed on an execution context. In block 506, if the epoch exists, then, in block 502, the epoch begins. In block 503, speculative execution is begun on a program code corresponding to the epoch. In block 504, the epoch ends. If the epoch that constitutes the predecessor in the sequential order ends successfully in block 507, then the execution context that executes the next epoch in sequence is made non-speculative, in block 505. If the epoch that constitutes the predecessor in the sequential order does not end successfully in block 507, then begin the epoch again, in block 502

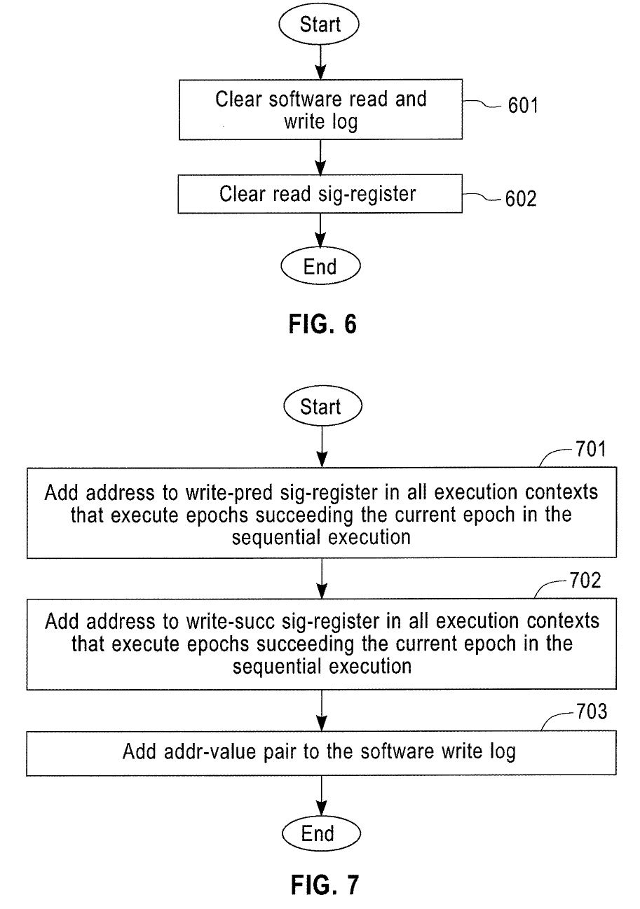

FIG. 6 is a flowchart illustrating the start of an epoch, according to an exemplary embodiment of the present invention. To begin an epoch, the software read and write logs are cleared (601) and the read sig-register is cleared (602). The allocation and management buffers for the purpose of storing speculative data may be done in software. Such a buffer is referred to herein as a write log. The write log includes address of location written and value written.

When an epoch starts execution, read and write-succ sig-registers of the execution context are reset, e.g., their values represent the empty set. The write-pred sig-register is unmodified.

Table 1 includes an example of pseudo-code for implementing the start an epoch of FIG. 6, according to an embodiment of the present invention.

TABLE 1

begin( )
clear read and write_log
clear read sig-register

Versioning occurs if a shared location is written by a speculative thread. In such event, a software write barrier is executed. FIG. 7 is a flowchart illustrating a speculative write operation, according to an exemplary embodiment of the present invention.

As illustrated in FIG. 7, a software write barrier is executed which records the address and value of the speculative write operation. In block 701, an address of a location that is written is added to a write-pred sig-register in all execution contexts that execute epochs succeeding the current epoch in the sequential execution. In block 702, an address of a location that is read is added to a write-succ sig-register in all execution contexts that execute epochs preceding the current epoch in the sequential execution. In block 703, an addr-value pair is added to the software write log.

Table 2 includes an example of pseudo-code for implementing the software write barrier of FIG. 7, according to an exemplary embodiment of the present invention.

TABLE 2

void write_barrier(TYPE* addr, TYPE val)

add addr to write sig-register in all other processors
add (addr, value)-pair in write_log

In addition to adding or updating an entry in the write log, a write barrier adds the address of the location that is written to the write-pred signature registers of other processors (701 and 702).

Dual to write operations, read operations need to retrieve values from speculative storage if the read refers to a shared location that may have been written before in the same epoch. This is achieved by a software read barrier that is associated with read operations to shared locations.

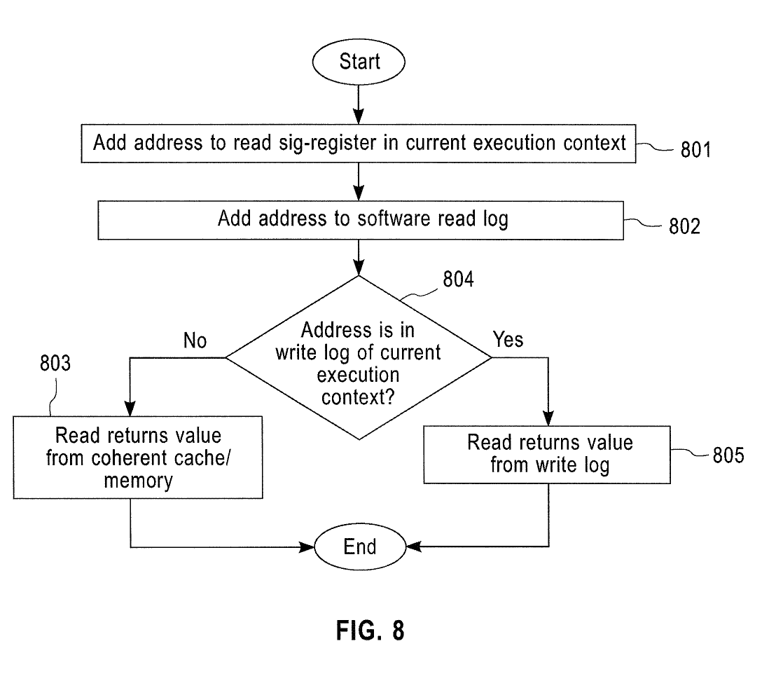

FIG. 8 is a flowchart illustrating a speculative read operation, according to an exemplary embodiment of the present invention. Referring to FIG. 8, the address of the location that is read is added to a read log (802), which is managed by software, and the to the read signature register of the current processor (801). The value returned by the read is determined either from memory (803) or from the write log (805) in case the current epoch wrote the same location earlier depending on whether the address is in a write log of the execution context.

Table 3 includes an example of pseudo-code for implementing the software read barrier of FIG. 8, according to an exemplary embodiment of the present invention.

TABLE 3

TYPE read_barrier(TYPE* addr)

add addr to read_log
add addr to read register
if (addr <in> write_log)

obtain value from write_log

else

obtain value from cache/memory

return value;

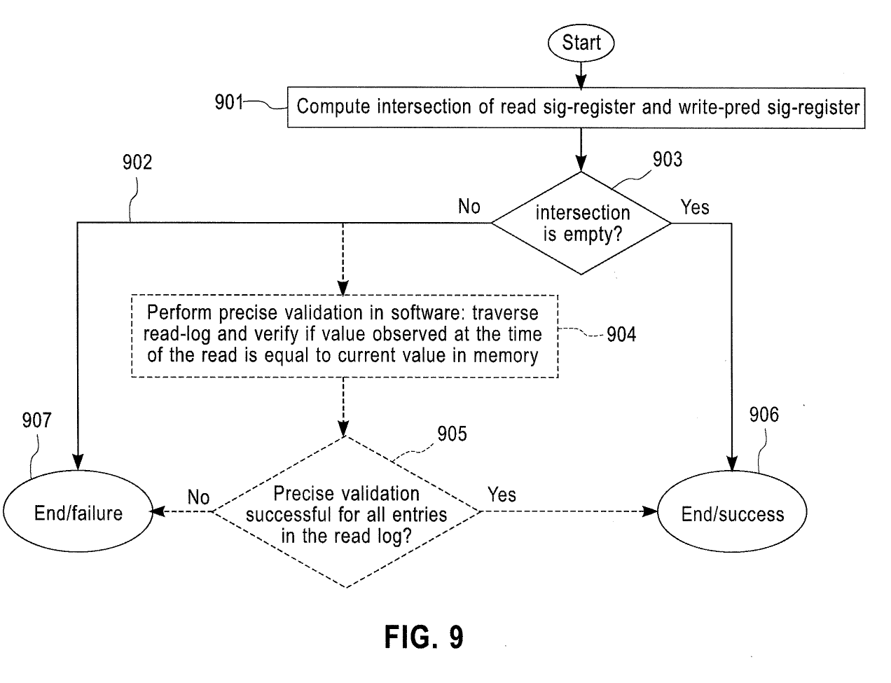

FIG. 9 is a flowchart illustrating the detection of data dependences among epochs, according to an exemplary embodiment of the present invention. This operation is also referred to as conflict detection or validation in the following.

Conflict detection is done through set intersection of the read sig-register and the write-pred sig register, in block 901. If the intersection is empty, in block 903, then the current execution context (performing the conflict detection) is free of conflicts with predecessor contexts (case 906). If the intersection is not empty, then a conflict may have occurred (case 907). The uncertainty over whether a conflict has occurred or not is due to the signatures being an over-approximation of sets of addresses. Hence a conflict detected on the basis of the signature intersection may be spurious (902). Thus, a more precise validation can be done, for example, in one of the following two ways:

(i) Iterate through the read-log and verify the values previously read are the same as those found in the coherence domain (case 904). This requires that the read log contains addresses and values. It should be ensured that all predecessor epoch(s) have their updates installed in the coherence domain before performing this precise validation. The cost of this validation is O(|read|). If the validation is successful for all entries in the read log, in block 905, then speculative execution succeeds and the execution context can complete the epoch (commit operation) (case 906). Otherwise, the execution context repeats execution of the epoch (roll back) (case 907).

(ii) Alternatively, intersect the precise read set with the precise write-set-pred of each processor core. Here, a precise representation of the read and write sets is retained in all cores. The cost of this validation for E execution contexts is O(P |read| |write|). This option is not shown in FIG. 9.

Conflict detection can be accelerated with hardware support. Conflict detection can be triggered explicitly by software as needed at commit time.

Table 4 includes an example of pseudo-code for implementing the conflict detection process of FIG. 9, according to an exemplary embodiment of the present invention.

TABLE 4
bool validate( )

bool valid = (read sig-register <intersect> write-pred sig-register ==
<emptyset>)
if (valid)

return true

else /* optional */

valid = true
foreach r in read_log

if (r.address != r.value)

return false

return valid

Conflict detection is done using the three signature registers in each execution context, e.g., hardware execution thread.

Operations of signature registers used during the execution of an epoch, according to an exemplary embodiment of the present invention, are described below: When an epoch performs a read operation on shared memory, the address of the location that is read is added to the read register. Only one read per location needs to be recorded, since the signature register represents a set on which add operations are idempotent.

When an epoch performs a write operation on shared memory, the address of the location is broadcast to other execution contexts (701 and 702), and the address is added to either the write-pred or write-succ register of other execution contexts. The choice of register depends on the pred/succ relation that writing context has with the other context where the write signature register is updated. An individual execution context is aware of its pred/succ relation relative to other execution contexts based on the total order among epochs that execute on the individual contexts. Only one write to a specific location needs to be broadcast, since the signature register represents a set on which add operations are idempotent. For example, an operation is idempotent if it can be applied a second time without altering the result obtained by the first application of the operation.

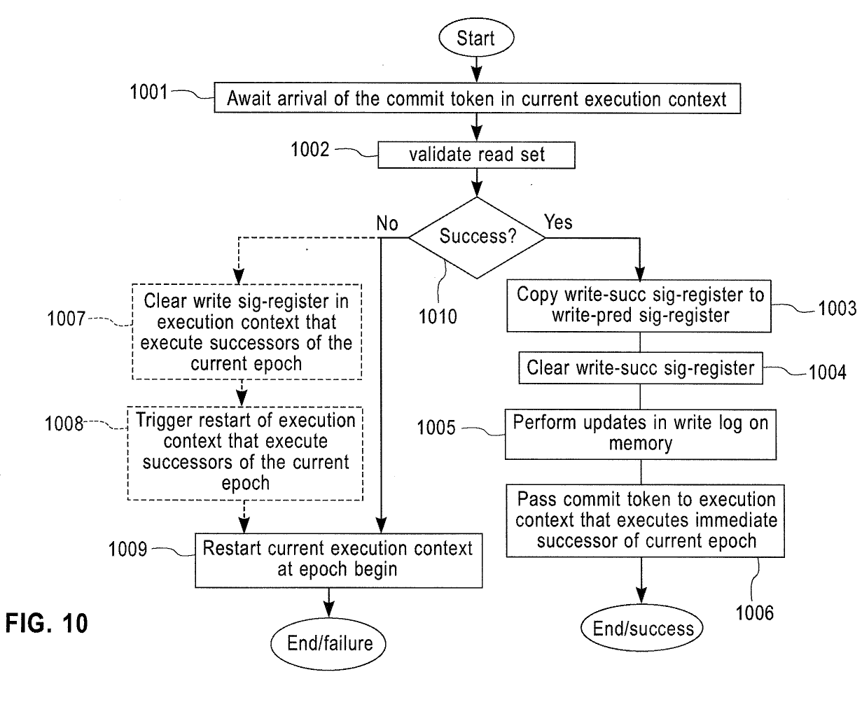

FIG. 10 is a flowchart that illustrates the algorithm to end an epoch, according to an exemplary embodiment of the present invention. FIG. 10 illustrates the commit operation. The capability to commit is specified by a ‘token’ cycling through the execution contexts in the order of the pred/succ relationship. Only one execution context can hold the token at a time. After the computation of the current epoch, an execution context awaits the arrival of the token (1001). t then validates its read set (conflict detection, 1002), and if successful, passes on the token explicitly and trickles out the updates of variables in the write set (1005). The updates do not need to happen atomically, and they do not happen on the critical path while holding the commit token.

At commit, the write-succ register is copied to the write-pred register (1003) and the write-succ register is cleared (1004). This prepares the execution context that ‘moves’ to the head of the speculation chain, and start execution of a new epoch.

An epoch is rolled back when a validation operation 1002 (conflict detection), fails. Rollback clears read-log, write-log and read register. The control transfer to the start of the epoch may be done in software, e.g., through the back-edge of a while loop or a light weight setjmp/longjmp (1009).

It is optional that an epoch signals its successor(s) on the occurrence of a failed validation (1007 and 1008). Such signaling may trigger an additional validation step in the successor epoch(s), which may detect the necessity for rollback early.

Table 5 includes an example of pseudo-code for implementing the ordered commit process of FIG. 10, according to an exemplary embodiment of the present invention.

TABLE 5

void commit( )

obtain commit token
if (validate( ))

swap write-pred sig-register and write-succ sig-register
clear write-succ sig-register
drain write_log to memory
release commit token

else

clear write_log
clear read_log
<optional>:

clear write-succ sig-register
rollback execution of successor epochs

transfer control to begin

The pseudo-code of Tables 2-5 is provided by way of example only and embodiments of the present invention are not to be construed as limited thereby.

Although exemplary embodiments of the present invention have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing exemplary embodiments may be made without departing from the scope of the disclosure.

What is claimed is:

1. A system for thread-level speculation, comprising:
a memory system for storing a program code;
a plurality of registers corresponding to one or more execution contexts, for storing sets of memory addresses that are accessed speculatively; and
a plurality of processors, each providing the one or more execution contexts, in communication with the memory system, wherein a processor of the plurality of processors executes the program code to implement method steps of:
dividing a program into a plurality of epochs to be executed in parallel by the system, wherein one of the epochs is executed non-speculatively and the other epochs are executed speculatively;
determining a current epoch to be executed on an execution context;
encoding addresses read during execution of the current epoch;
encoding addresses written during execution of predecessor epochs of the current epoch; and
encoding addresses written during execution of successor epochs of the current epoch.

2. The system of claim 1, wherein the speculative execution includes executing write barrier operations to record memory addresses and values of speculative write operations in registers of other execution contexts.

3. The system of claim 1, wherein the speculative execution includes executing read barrier operations to record memory addresses of speculative read operations using the plurality of registers and a read log.

4. The system of claim 1, wherein the speculative execution includes detecting data dependencies among epochs using the plurality of registers.

5. The system of claim 1, wherein the speculative execution includes a commit operation that completes an epoch.

6. The system of claim 1, wherein determining the current epoch to be executed on the execution context comprises choosing the next epoch in the linear order that has not started execution.

7. The system of claim 1, further comprising the step of designating one of the processors for performing non-speculative execution of an epoch.

8. A system for thread-level speculation, comprising:
a memory system for storing a program code;
a first register, a second register and a third register, the first, second and third registers for storing sets of memory addresses that are speculatively accessed; and
a plurality of processors, each providing the one or more execution contexts, in communication with the memory system, wherein a processor of the plurality of processors executes the program code to implement method steps of:
dividing a program into a plurality of epochs to be executed in parallel by the system, wherein one of the epochs is executed non-speculatively and the other epochs are executed speculatively; and
determining a current epoch to be executed on an execution context,
wherein the first register stores addresses read during execution of a current epoch, the second register stores addresses written during the execution of predecessor epochs of the current epoch, and the third register stores addresses written during the execution of successor epochs of the current epoch.

9. The system of claim 8, further comprising a fourth register that specifies whether an execution context is speculative or non-speculative.

10. The system of claim 8, further comprising a fifth register that specifies the linear order of the current epoch.

11. The system of claim 8, wherein the speculative execution includes executing write barrier operations to record memory addresses and values of speculative write operations in registers of other execution contexts.

12. The system of claim 8, wherein the speculative execution includes executing read barrier operations to record memory addresses of speculative read operations using the plurality of registers and a read log.

13. The system of claim 8, wherein the speculative execution includes detecting data dependencies among epochs using the plurality of registers.

14. The system of claim 8, wherein the speculative execution includes a commit operation that completes an epoch.

15. The system of claim 8, wherein determining the current epoch to be executed on the execution context comprises choosing the next epoch in the linear order that has not started execution.

16. The system of claim 8, further comprising the step of designating one of the processors for performing non-speculative execution of an epoch.
